(19) United States
(12) Patent Application Publication
(10) Pub. No.: US 2010/0100292 A1
(43) Pub. Date: Apr. 22, 2010

(54) ENGINE SERVO LOADING DEVICE AND CONTROL METHOD FOR DYNAMIC OPTIMIZATION SEARCHING OPERATION OF THE DEVICE

(75) Inventor: Hong Lv, Guilin City (CN)

Correspondence Address: CALFEE HALTER & GRISWOLD, LLP, 800 SUPERIOR AVENUE, SUITE 1400, CLEVELAND, OH, 44114, US

(73) Assignee: GUILIN GEELY STARS OIL-ELECTRIC HYBRID ENGINE CO.

(21) Appl. No.: 12/528,665

(22) PCT Filed: Aug. 29, 2007
(86) PCT No.: PCT/CN07/02598

§ 371 Date: Aug. 26, 2009

(30) Foreign Application Priority Data
Mar. 1, 2007 (CN) 200720078688.0
Mar. 6, 2007 (CN) 200710048605.8

(51) Int. Cl. G06F 19/00

(52) U.S. Cl. 701/60

(57) ABSTRACT

A dynamic optimization searching method for a torque servo loading device of an engine is disclosed, the torque servo loading device includes a motor, a torque servo driver, a primary control unit, and a mass flow sensor; the primary control unit stores therein an optimal efficiency operation curve of the engine and data of fuel consumption value per unit of mechanical power of the engine at each point on the curve; the method includes: detecting current operation parameters of the engine; making the engine operate according to the current optimal efficiency operation curve; changing the current optimal fuel efficiency torque by an optimization searching step to obtain an optimization searching torque; making the engine operate for an optimization searching measurement-calculation time period under the optimization searching torque; calculating the fuel consumption value per unit of mechanical power of the engine; comparing the calculated fuel consumption value per unit of mechanical power with a stored fuel consumption value per unit of mechanical power; and storing the optimization searching torque in the optimal efficiency operation curve, and storing the calculated fuel consumption value per unit of mechanical power, if the calculated fuel consumption value per unit of mechanical power is less than the stored fuel consumption value per unit of mechanical power.

### FIELD OF INVENTION

The present invention relates to engine control, particularly to a fuel engine servo loading device and a control method for dynamic optimization searching of the device.

### BACKGROUND OF INVENTION

It has been testified that there may exist several different operation points of cooperation between the rotation speed and torque at which the fuel engine is capable of outputting a certain mechanical power. Among the operation points at which the engine is outputting the identical mechanical power, there is a minimal fuel consumption point, i.e., the optimal cooperation operation point of the rotation speed and torque. A curve plotted by connecting all the minimal fuel consumption points of different output power and then smoothing the connection is the optimal efficiency operation curve of the engine. According to such curve, the efficiency of the fuel engine is maximized, and the obtained mechanical power would be the largest by consuming the same amount of fuel.

In view of the above, when the fuel engine is operating under a certain rotation speed, if the torque applied to its axle is equal to the torque required according to the optimal efficiency operation curve under such rotation speed, it is said that the engine is operating at the optimal efficiency point under the current rotation speed. Under different rotation speeds, the engine always keeps the torque applied to the axle identical to the torque required by the optimal efficiency operation curve, i.e., the rotation speed and torque of the engine meet the requirement of the optimal efficiency operation curve, therefore the engine can obtain the maximum mechanical power by consuming the same amount of fuel, achieving the best economy operation status.

In the current vehicle, all types of fuel engine are provided with mechanical transmitting mechanisms, such as a step transmission or a continuously variable transmission (CVT), to regulate the matched rotation speed and torque, and expect the matched rotation speed and torque of the fuel engine to approach the optimal efficiency operation curve.

The most widely implemented step transmission includes 4-5 shift positions. Therefore a simple regulation of speed can be executed, but the speed ratio cannot be regulated continuously. In the case that the loading torque varies due to wind resistance, weight loading, road conditions, environment, and abrasion, etc., the torques applied to the engine axle at different rotation speeds of different shift positions can seldom meet the requirement of the optimal efficiency operation curve.

A continuously variable transmission is mainly consisted of a driving gear set, a driven gear set, a metal belt, and a hydraulic pump, and continuously varies the speed ratio by changing the operation radius under which the tapered surfaces of the driving and driven gears engage the V shaped transmitting belt, therefore realizing better matching of the engine rotation speed and torque. The prior art continuously variable transmission, however, suffers obvious drawbacks: first, the manufacturing cost is high due to complexity of its mechanical configuration; second, because the regulating speed is slow due to the large inertia of the mechanical configuration and the hydraulic system, when the engine throttle or the exterior loading torque get changed dynamically, especially when the road conditions, the throttle, and the speed change frequently, the continuously variable transmission (CVT) cannot accurately regulate the speed ratio swiftly, therefore the fuel engine can hardly operate according to the optimal efficiency operation curve as a result; finally, the transmitting efficiency of the continuously variable transmission (CVT) is lower than that of the ordinary gear transmission. All these drawbacks influence the implementing of the CVT negatively.

The fuel engine may be provided with a torque servo loading device, which can, using the motor of the servo device, apply to the fuel engine the corresponding torque based on the matching torque data obtained under the current rotation speed according to the actual rotation speed of the engine and the optimal efficiency operation curve pre-stored in the primary control unit computer. That is, such provision makes the fuel engine operate according to the pre-stored optimal efficiency operation curve, therefore the operation efficiency and energy saving of the fuel engine can be improved dramatically.

However, with the diverse characteristics of even the same type of fuel engine which cannot be unified, further taking into account of the following exterior factors of gradual deterioration of the components of the fuel engine as time passes by, variation of the used fuel, variation of the air/fuel ratio, and variation of the temperature of the engine, the actual optimal efficiency operation curve of the fuel engine always deviates from the optimal efficiency operation curve previously specified by the manufacturer or obtained experimentally. In other words, when the fuel engine is controlled according to the optimal efficiency operation curve pre-stored in the servo loading device, the torque calculated based on the current rotation speed according to the stored optimal efficiency operation curve is not the torque matching such rotation speed for obtaining the optimal efficiency. That is, the servo loading device fails to make the fuel engine operate according to the altered real optimal efficiency operation curve, and the energy saving effect will be influenced.

### SUMMARY OF INVENTION

The data of matched rotation speed and torque of the optimal efficiency of the fuel engine will change due to variation of the factors such as the status of components of engine and the quality of the fuel. The fuel engine servo loading device and the operation control method thereof according to the present invention are capable of perform dynamic optimization searching automatically and real-time correcting the engine optimal efficiency operation curve, so as to keep the engine operate according to the actual optimal efficiency operation curve, and achieve the goal of further saving energy.

The object of the present invention is to provide a fuel engine servo loading device and a control method of dynamic optimization searching operation of the device, for conducting the optimization searching correction based on the optimal efficiency operation curve pre-stored in the servo loading device, constantly looking for the value of the optimal efficiency torque matching the current rotation speed and constantly updating the stored optimal efficiency operation curve according to the current power and the fuel consumption status, to make the fuel engine operate according to the real optimal efficiency curve.

The present invention provides a dynamic optimization searching method for a servo loading device of an engine, the servo loading device includes a motor, a torque servo driver, a primary control unit, and a mass flow sensor, the primary control unit stores therein an optimal efficiency operation curve of the engine and data of fuel consumption value per unit of mechanical power of the engine at each point on the curve, which are adapted for performing the torque servo loading and dynamic optimization searching control of the engine, characterized in that, the method includes the following steps: 1) detecting current operation parameters of the engine; 2) obtaining current optimal fuel efficiency torque (T) under the current operation parameters according to the optimal efficiency operation curve, and controlling the motor to servo load the engine through the torque servo driver, so as to make the engine operate according to the current optimal efficiency operation curve; 3) changing the current optimal fuel efficiency torque (T) by an optimization searching step (dT) to obtain an optimization searching torque; 4) torque loading the engine through the torque servo loading device, to make the engine operate for an optimization searching measurement-calculation time period (dt) under the optimization searching torque; 5) calculating the fuel consumption value per unit of mechanical power of the engine under the optimization searching torque during the optimization searching measurement-calculation time period; 6) comparing the calculated fuel consumption value per unit of mechanical power with a stored fuel consumption value per unit of mechanical power corresponding to the current optimal fuel efficiency torque (T) on the optimal efficiency operation curve; and 7) storing the optimization searching torque as substitution of the current optimal fuel efficiency torque (T) in the optimal efficiency operation curve, and storing the calculated fuel consumption value per unit of mechanical power correspondingly, if the calculated fuel consumption value per unit of mechanical power is less than the stored fuel consumption value per unit of mechanical power.

The present invention further provides a servo loading device of an engine, including: a motor which includes a first rotor and a second rotor, the first rotor of the motor is directly connected to an output axle of the engine, the second rotor of the motor is directly connected to a driving axle, the power is transmitted between the first rotor and the second rotor through electromagnetic coupling; and a torque servo driver, which controls the electromagnetic torque between the first rotor and the second rotor according to preset conditions, thereby controlling torque loading of the engine and output torque of the driving axle consequently; wherein each of the first and second rotors is provided with speed and/or position sensor so as to facilitate control of the motor by the torque servo driver, the servo loading device of the engine further includes a controller which performs the dynamic optimization searching method as aforementioned.

The optimization searching program assigns two optimization searching flags to determine the direction for optimization searching when conducting optimization searching. For instance, assign “+” to the optimization searching flag and conduct the optimization searching with T+dT in the positive direction when the optimization searching begins with the rotation speed N. In the case that the amount of fuel consumption when the torque is T+dT is less than the fuel consumption data on the optimal efficiency curve with the rotation speed N (i.e., when the optimization searching is successful), the optimization searching flag “+” keeps unchanged, the optimization searching is continued in such direction when the rotation speed N is unchanged. Otherwise, if the optimization searching fails, then the optimization searching flag changes into “−”, and the optimization searching begins with T−dT. Similar to the above, the optimization searching flag “−” keeps unchanged if the optimization searching is successful, and the optimization searching flag changes back to “+” if the optimization searching fails. Recycle the optimization searching and update T as such, conduct the optimization searching with T+dT or T−dT according to the orientation of the optimization searching flag when the rotation speed keeps unchanged; and restart the cycle after resetting the optimization searching flag to the initial value when the rotation speed gets changed. Therefore the data of the optimal efficiency operation curve stored in the computer of the primary control unit can keep updating toward the actual optimal status.

In the control method of the dynamic optimization searching operation for the servo loading device of the fuel engine according to the present invention, the matched torque for optimization searching is regulated under different rotation speed, the computer of the primary control unit dynamically corrects and constantly updates the pre-stored data of the optimal efficiency operation curve, so as to keep the fuel engine operating according to the current actual optimal efficiency curve.

The advantages of the fuel engine servo loading device and the control method of dynamic optimization searching according to the present invention lie in the following: 1. substituting the mechanical transmission and clutch with the servo driver attached to the engine axle, the servo driver regulating the torque applied to the engine axle by the motor in a torque servo manner, ensuring the fuel engine real-time operating according to the optimal efficiency operation curve, realizing the maximum mechanical power output when consuming the same amount of fuel; 2. the present device excluding the direct mechanical connection between the output axle of the fuel engine and the exterior loading, and even if the exterior loading torque or the rotation speed of the fuel engine changing frequently, the servo driver can constantly, swiftly, and accurately apply the matched torque to the engine in real time according to the requirement of the optimal efficiency operation curve, realizing the maximum mechanical power output when the engine combusting the same amount of fuel; 3. the device and control method of the present invention conduct dynamic optimization searching based on the pre-stored optimal efficiency operation curve, therefore even if the status of the engine gets changed and the fuel quality is different, the value of the optimal torque matching the current speed can be obtained, so as to control the torque of the output axle of the fuel engine and keep the same operate according to the actual optimal efficiency operation curve; storing in the computer of the primary control unit the torque value matching such rotation speed, the torque value is obtained through the optimization searching, therefore the optimal efficiency curve data stored in the computer of the primary control unit being updated constantly; 4. comparing with conducting the servo control by using solely the pre-stored optimal efficiency curve, the device and control method of the present invention can achieve a better energy saving effect; and 5. the device and control method of the present invention are applicable to all kinds of internal combustion engines, especially to the fuel-electricity hybrid electric motor vehicle to fulfill the purpose of saving energy and decreasing emission.

### DESCRIPTION OF DRAWINGS

FIG. 1 is an illustration of the exemplified configuration of the servo loading device of the fuel engine according to the present invention;

FIG. 2 is an optimal efficiency operation curve of a gasoline engine with displacement of 1.8 L, wherein the vertical coordinate represents the torque of the output axle of the engine (unit: N·m), the horizontal coordinate represents the rotation speed of the output axle of the engine (unit: rpm), and wherein the thin dashed line is an equivalent power line (unit: kW), the thin solid line is an equivalent power consumption line BE (unit: g/kWh), the thick solid line is the optimal efficiency operation curve of the engine, while the thick dashed line is the maximum torque limitation of the engine; and

FIG. 3 is the block diagram of the program of the dynamic optimization searching operation control method of the servo loading device of the fuel engine according to the present invention.

### DESCRIPTION OF PREFERRED EMBODIMENT

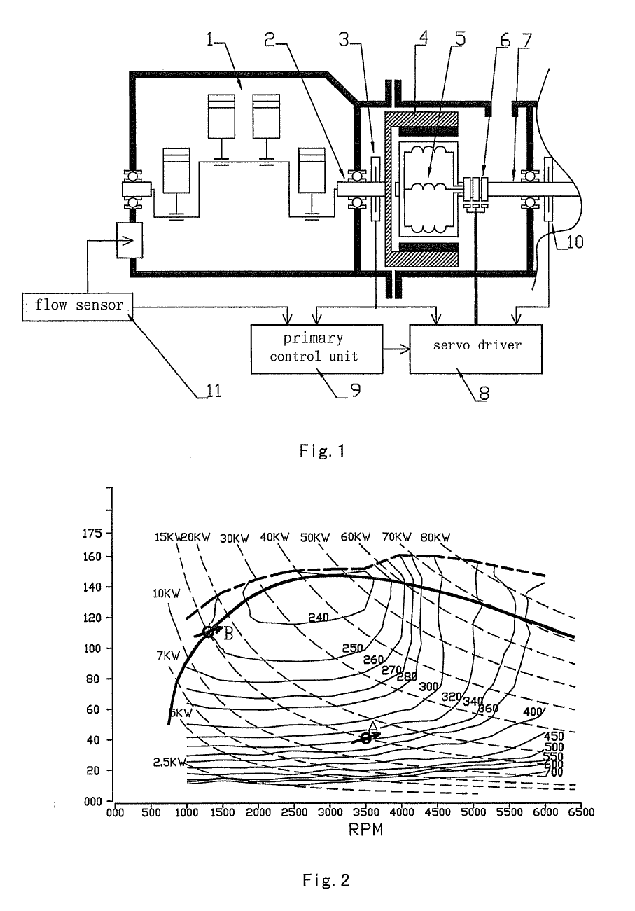

The configuration of an embodiment of a servo loading device of a fuel engine according to the present invention is shown in FIG. 1. The fuel engine 1 is connected to a servo control device which includes a permanent magnetic synchronous motor and a servo driver. A first rotor 4 of the motor is connected directly to an output axle 2 of the fuel engine 1. A permanent magnetic material is embedded in the first rotor 4 of the motor, in which a second rotor 5 is provided. The second rotor 5 is the winding around an iron core, and an axle of the second rotor 5 is an output axle 7 of the device of the present invention. A speed/position sensor 3 is provided on the first rotor 4. The speed/position sensor 3 is connected to a primary control unit 9 and a servo driver 8. A position sensor 10 is provided on the axle of the second rotor 5, and the position sensor 10 is connected with the servo driver 8. The primary control unit 9 is connected to the servo driver 8. The servo driver 8 is connected to the winding of the second rotor 5 through a ring collector 6. A main body of the primary control unit 9 is a computer, which stores therein data of matched rotation speed and torque of an optimal efficiency operation curve of the fuel engine 1 and a fuel consumption value per unit of mechanical power at each point on such curve, i.e., the data of the rotation speed and the torque of the optimal efficiency curve and BE value at each point on the curve shown in FIG. 2. The computer of the primary control unit also stores therein an automatic optimization searching program. A mass flow sensor 11 is further provided on a fuel route of the fuel engine 1, which is also connected with the primary control unit 9.

The optimal efficiency operation curve of the fuel engine and the fuel consumption value per unit of mechanical power at each point on the curve can be specified by the manufacturer or obtained experimentally using special measuring apparatus.

The servo loading device of the fuel engine of the present invention can also employ a brushless DC motor which has a similar configuration to the aforementioned.

A relative position detecting device can also be provided between the second rotor 5 and the first rotor 4, the relative position detecting device is connected to the servo driver 8, for substituting the position sensor 10 on the second rotor 5 and the speed/position sensor 3 on the first rotor 4 to conduct a position detection of the second rotor 5 and the first rotor 4, and send the relative position signal thereof directly to the servo driver 8.

The first rotor 4 of the device of the present invention can also be the winding around the iron core, the ring collector 6 is provided on the output axle 2 of the engine, and the winding is connected to the servo driver 8 through the ring collector 6. The second rotor 5 is the rotor embedded with the permanent magnetic material for providing magnetic field to the first rotor 4, while the remaining configuration is identical to the aforementioned.

The fuel engine is provided with the servo loading device which matches the biggest torque and the largest rotation speed thereof. The speed/position sensor 3 is provided on the first rotor 4 of the motor, which is connected to the computer of the primary control unit 9 and the servo driver 8. The mass flow sensor 11 is also provided on the fuel route of the fuel engine 1, which is connected to the computer of the primary control unit 9. The position sensor 10 is provided on the axle of the second rotor 5 of the motor, which is connected to the servo driver 8.

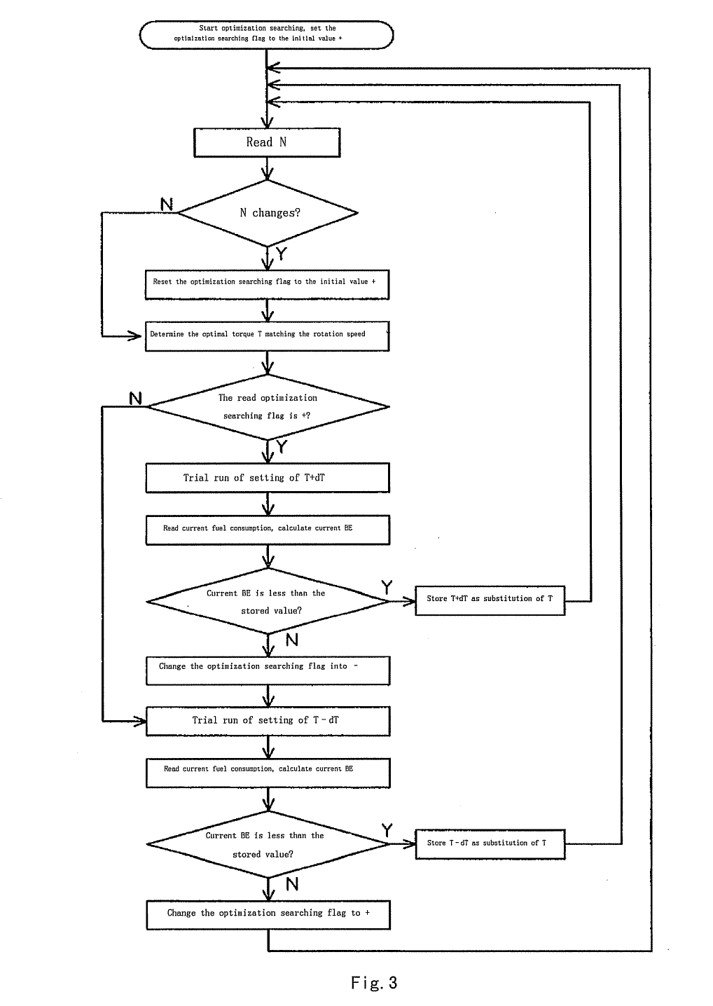

An exemplified block diagram of the program of the control method of dynamic optimization searching operation of the fuel engine servo loading device is shown in FIG. 3 which is referred to hereinafter to explain the method.

When the fuel engine 1 is in operation, the speed/position sensor 3 monitors the current rotation speed and position of the first rotor 4 in real time, sends the speed signal N (rpm) to the primary control unit 9 in real time, and sends the position signal to the servo driver 8. The position sensor 10 monitors the current position of the second rotor 5 in real time, and sends the position signal to the servo driver 8.

The primary control unit 9 determines the matching optimal torque T (N*m) according to the pre-stored optimal efficiency curve based on the current speed signal N, and sends the setting of the torque T to the servo driver 8. The servo driver 8 loads the current vector of the winding of the second rotor 5 according to the setting of the torque from the primary control unit and the relative position signal of the second rotor 5 and the first rotor 4 obtained based on the position signal of the second rotor 5 and the first rotor 4, subjects the torque T to the output axle of the engine, and at the meantime, the output axle of the second rotor 5 outputs the same torque to the outside.

Based on the torque value T obtained in above manner, the primary control unit 9 executes the automatic optimization searching program which starts the optimization searching by increasing the torque by an optimization searching step dT automatically, and assigning positive to an optimization searching flag. The primary control unit 9 sends the setting of T+dT to the servo driver 8, and the servo driver 8 loads the current vector of the winding of the second rotor 5 according to the setting of the torque from the primary control unit and the relative position signal of the second rotor 5 and the first rotor 4, and controls the fuel engine 1 to conduct trial operation with torque T+dT.

The primary control unit obtains the amount of fuel consumption within the optimization searching measurement-calculation period dt (h) under the status with the speed N and torque T+dT from the mass flow sensor on the fuel route, and calculates the mechanical power output by the fuel engine during the time period dt, W=N×(T+dT)×dt/9550(kWh), based on the current speed N and torque T+dT, therefore obtaining the fuel consumption value per unit of mechanical power of the fuel engine (i.e., fuel consumption amount of mechanical power per kilowatt hour) during the period of the current trial operation.

In the case that the rotation speed is N, the fuel consumption data per unit of mechanical power of the fuel engine 1 under the optimization searching trial operation torque (T+dT) is compared with the fuel consumption data at corresponding point on the optimal efficiency operation curve under the rotation speed N stored in the computer of the primary control unit 9. If the fuel consumption amount per unit of mechanical power at the trial operation point within the optimization searching measurement-calculation time period dt is less than the index of the fuel consumption on the optimal efficiency operation curve, i.e., optimization searching is successful, then T+dT is stored as substitution of the original T in the computer of the primary control unit 9, the optimization searching flag is kept as positive, and the computer of the primary control unit 9 continues optimization searching with T+dT (note that the T has been updated this time) in the aforementioned manner. In contrast, in the trial operation with the T+dT torque, if the fuel consumption amount per unit of mechanical power is larger than the data on the optimal efficiency operation curve, i.e., optimization searching is failed, then the optimization searching flag is changed to negative, and the optimization searching is conducted in the opposite direction. The computer of the primary control unit 9 sends T−dT torque to the servo driver 8, controls the trial operation of the output axle of the fuel engine 1 under such torque, and compares the fuel consumption thereof. If the fuel consumption amount per unit of mechanical power at T−dT trial operation point within the optimization searching measurement-calculation time period dt is less than the index of the fuel consumption on the optimal efficiency operation curve, i.e., optimization searching is successful, then T−dT is stored as substitution of the original T in the computer of the primary control unit 9, the optimization searching flag is kept as negative, and the computer of the primary control unit 9 continues optimization searching with T−dT (note that the T has been updated this time) in the aforementioned manner. In contrast, in the trial operation with the T−dT torque, if the fuel consumption amount per unit of mechanical power is larger than the data on the optimal efficiency operation curve, then the optimization searching flag is changed to positive, and the optimization searching is conducted in the positive direction again.

In the case that the rotation speed N is constant, the repeated cycle, gradual optimization searching and updating are conducted with T+dT and T−dT, and the optimization searching cycle is restarted once again if the rotation speed varies. Therefore, the data of the matched rotation speed and torque on the optimal efficiency operation curve can be updated constantly into the actual optimal data, the fuel engine 1 can always operate according to the actual optimal efficiency curve, and the optimal energy saving could be achieved.

The computer can interfere in, stop, or restart the automatic optimization searching program as needed. When the automatic optimization searching program is stopped, the primary control unit 9 determines the matching optimal torque T according to the stored optimal efficiency curve based on the current speed signal N, and sends the setting of torque T to the servo driver 8, controlling the operation of the engine. The restarted automatic optimization searching program still proceeds according to the flow of the aforementioned steps.

The optimization searching step dT is selected in considering following two criteria: first, the optimization searching should be fast enough, this requires a lager dT; second, the points of the optimization searching should be dense enough to avoid oversight of the optimal point by dT, this requires dT small enough. It is preferable that dT is within the range of 0.1-10 N*m, which is not limited hereto. The value of dT is determined according to the operational speed of the computer of the primary control unit 9 and the rate with which the engine optimal economic operation curve varies. If the operational speed of the computer of the primary control unit 9 is fast, the dT is small, if the rate with which the engine optimal economic operation curve varies is fast, the dT is large. The dT is less than 5% of the nominal torque to avoid the control oscillation.

It is preferable that the optimization searching measurement-calculation time period dt is within the range of 0.1-5 seconds, which is not limited hereto and is particularly relevant to the measuring speed and accuracy of the fuel consumption by the mass flow sensor 11. If the measuring speed of the fuel consumption is fast and the accuracy is high, then dt is small.

In one embodiment, a gasoline engine with displacement of 1.8 L is provided with the servo loading device of the present invention, and operates with the dynamical operation control method of the present invention. As shown by point A in FIG. 2, in the case that the engine operates under the work condition of 15kW output power and keeps unchanged, if the engine operates on the uneconomic operation point of 3500 rpm and 40.9 N*m, then the fuel consumption per unit of output mechanical power thereof is 335 g/kWh. However, after the engine operation point being regulated to the point B (i.e., 1302 rpm and 110 N*m) on the optimal economic operation curve by the loading control device and the operation control method of the present invention, the fuel consumption per unit of output mechanical power thereof is decreased to 250 g/kcWh, and the fuel consumption is decreased by 25.4%. When the optimal efficiency operation curve is actually offset from such point by 10% due to the change of fuel quality or engine wear, the fuel consumption would be 1%-2% larger than the lowest value if the control is conducted under the torque of original curve. The device and method of the present invention update the optimal efficiency curve dynamically, making the fuel consumption lowest with output of the same mechanical power. The fuel saving effect would vary when considering the operation point and the offset status, but the optimal energy saving status can always be ensured.

1. A dynamic optimization searching method for a servo loading device of an engine, the servo loading device including a motor, a torque servo driver, a primary control unit, and a mass flow sensor, the primary control unit storing therein an optimal efficiency operation curve of the engine and data of fuel consumption value per unit of mechanical power of the engine at each point on the curve, which are adapted for performing the torque servo loading and dynamic optimization searching control of the engine, characterized in that, the method includes the following steps:
a) detecting current operation parameters of the engine;
b) obtaining current optimal fuel efficiency torque (T) under the current operation parameters according to the optimal efficiency operation curve, and controlling the motor to servo load the engine through the torque servo driver, so as to make the engine operate following the current optimal efficiency operation curve;
c) changing the current optimal fuel efficiency torque (T) by an optimization searching step (dT) to obtain an optimization searching torque;
d) torque loading the engine through the torque servo loading device, so as to make the engine operate for an optimization searching measurement-calculation time period (dt) under the optimization searching torque;
e) calculating the fuel consumption value per unit of mechanical power of the engine under the optimization searching torque during the optimization searching measurement-calculation time period;
f) comparing the calculated fuel consumption value per unit of mechanical power with a stored fuel consumption value per unit of mechanical power corresponding to the current optimal fuel efficiency torque (T) on the optimal efficiency operation curve; and
g) storing the optimization searching torque as substitution of the current optimal fuel efficiency torque (T) in the optimal efficiency operation curve, and storing the calculated fuel consumption value per unit of mechanical power correspondingly, if the calculated fuel consumption value per unit of mechanical power is less than the stored fuel consumption value per unit of mechanical power.

2. The method according to claim 1, wherein in the servo loading device, the motor includes a first rotor and a second rotor, the first rotor of the motor is connected directly to an output axle of the engine, the second rotor of the motor is connected directly to a driving axle, and the power is transmitted between the first rotor and the second rotor through an electromagnetic coupling, and
the torque servo driver controls the electromagnetic torque between the first rotor and the second rotor, thereby controlling the torque loading of the engine and the output torque of the driving axle consequently.

3. The method according to claim 1, wherein said changing the current optimal fuel efficiency torque to obtain the optimization searching torque includes increasing or decreasing by one optimization searching step (dT).

4. The method according to claim 1, further includes setting an optimization searching flag, a status of the optimization searching flag remains unchanged and optimization searching is conducted in the same direction if the calculated fuel consumption value per unit of mechanical power is less than the stored fuel consumption value per unit of mechanical power;
and the status of the optimization searching flag gets changed and the optimization searching is conducted in the opposite direction if the calculated fuel consumption value per unit of mechanical power is larger than or equal to the stored fuel consumption value per unit of mechanical power.

5. The method according to claim 4, includes resetting the optimization searching flag and restarting from the step a) to step g) when the current operation parameters of the engine gets changed.

6. The method according to claim 5, wherein the current operation parameters of the engine include power and rotation speed of the engine.

7. The method according to claim 1, wherein the device includes the mass flow sensor on a fuel route, and the fuel consumption value per unit of mechanical power of the engine under the optimization searching torque within the optimization searching measurement-calculation time period is calculated based on a signal from the mass flow sensor.

8. The method according to claim 2, wherein said torque loading the engine includes, the torque servo driver controls a current vector output to a winding of the motor according to a torque setting of the primary control unit and a relative position relation between the first rotor and the second rotor, and controls the electromagnetic torque therebetween consequently.

9. The method according to claim 1, wherein the optimization searching step (dT) is 0.1 to 10 N·m.

10. The method according to claim 1, wherein the optimization searching step (dT) is less than 5% of a nominal torque of the engine.

11. The method according to claim 1, wherein the optimization searching measurement-calculation time period is between 0.1 and 5 seconds.

12. A servo loading device of an engine, including:
a motor including a first rotor and a second rotor, the first rotor of the motor being directly connected to an output axle of the engine, the second rotor of the motor being directly connected to a driving axle, the power being transmitted between the first rotor and the second rotor through electromagnetic coupling; and
a torque servo driver, which controls the electromagnetic torque between the first rotor and the second rotor according to preset conditions, thereby controlling torque loading of the engine and output torque of the driving axle consequently;
wherein each of the first and second rotors is provided with a speed and/or position sensor so as to facilitate control of the motor by the torque servo driver, the servo loading device of the engine further includes a controller programmed to access an optimal efficiency operation curve of the engine and data of fuel consumption valve per unit of mechanical power of the engine at each point on the curve and perform a dynamic optimization searching method that comprises
a) detecting current operation parameters of the engine;
b) obtaining current optimal fuel efficiency torque (T) under the current operation parameters according to the optimal efficiency operation curve, and controlling the motor to servo load the engine through the torque servo driver, so as to make the engine operate following the current optimal efficiency operation curve;
c) changing the current optimal fuel efficiency torque (T) by an optimization searching step (dT) to obtain an optimization searching torque;
d) torque loading the engine through the torque servo loading device, so as to make the engine operate for an optimization searching measurement-calculation time period (dt) under the optimization searching torque;
e) calculating the fuel consumption value per unit of mechanical power of the engine under the optimization searching torque during the optimization searching measurement-calculation time period;
f) comparing the calculated fuel consumption value per unit of mechanical power with a stored fuel consumption value per unit of mechanical power corresponding to the current optimal fuel efficiency torque (T) on the optimal efficiency operation curve; and
g) storing the optimization searching torque as substitution of the current optimal fuel efficiency torque (T) in the optimal efficiency operation curve, and storing the calculated fuel consumption value per unit of mechanical power correspondingly, if the calculated fuel consumption value per unit of mechanical power is less than the stored fuel consumption value per unit of mechanical power.
